(19) United States
(12) Patent Application Publication
(10) Pub. No.: US 2024/0213838 A1
(43) Pub. Date: Jun. 27, 2024

(54) ROTOR, ROTARY ELECTRIC MACHINE, AND DRIVE APPARATUS

(71) Applicant: NIDEC CORPORATION, Kyoto (JP)

(72) Inventor: Ippei YAMASAKI, Kyoto (JP)

(21) Appl. No.: 18/457,344

(22) Filed: Aug. 29, 2023

(30) Foreign Application Priority Data
Dec. 26, 2022 (JP) 2022-208595

(51) Int. Cl. H02K 1/32; H02K 1/276

(52) U.S. Cl. CPC H02K 1/32; H02K 1/276; B60K 1/00

(57) ABSTRACT

The present invention is a rotor rotatable about a center axis, and includes a rotor core having a plurality of magnet holes and a flow path through which a refrigerant flows, and a plurality of magnets accommodated in each of the plurality of magnet holes. The plurality of magnet holes and the flow path each extend in the axial direction. In a cross section orthogonal to the center axis, the flow path is surrounded by a plurality of magnets. The thermal resistance between the first outer surface facing the opposite side to the flow path side of each of the plurality of magnets and the rotor core is larger than the thermal resistance between the second outer surface facing the flow path side of each of the plurality of magnets and the rotor core.

### CROSS-REFERENCE TO RELATED APPLICATIONS

The present invention claims priority under 35 U.S.C. § 119 to Japanese Patent Application No. 2022-208295 filed on Dec. 26, 2022, the entire content of which is incorporated herein by reference.

### FIELD OF THE INVENTION

The present invention relates to a rotor, a rotary electric machine, and a drive apparatus.

### BACKGROUND

A rotor in which a permanent magnet is accommodated in a magnet hole of a rotor core is known. For example, there is a rotor that includes a first thermal conductive layer between a permanent magnet and a surface of a magnet hole facing radially outside, and a second thermal conductive layer between the permanent magnet and a surface of the magnet hole facing radially inside, the second thermal conductive layer having a thermal conductivity lower than that of the first thermal conductive layer, and suppresses a temperature rise of the permanent magnet by releasing heat of the permanent magnet to a shaft disposed at the center of a rotor core.

In the rotor described above, the heat of the permanent magnet is released to the shaft disposed at the center of the rotor core via the second thermal conductive layer and the rotor core. Therefore, when the distance between the permanent magnet and the shaft is long, the heat of the permanent magnet is hardly released, and there is a possibility that the temperature rise of the permanent magnet cannot be sufficiently suppressed.

### SUMMARY

One aspect of an exemplary rotor of the present invention is a rotor rotatable about a center axis, and includes a rotor core having a plurality of magnet holes and a flow path through which a refrigerant flows, and a plurality of magnets accommodated in each of the plurality of magnet holes. The plurality of magnet holes and the flow path each extend in the axial direction. In a cross section orthogonal to the center axis, the flow path is surrounded by a plurality of magnets. The thermal resistance between the first outer surface facing the opposite side to the flow path side of each of the plurality of magnets and the rotor core is larger than the thermal resistance between the second outer surface facing the flow path side of each of the plurality of magnets and the rotor core.

One aspect of an exemplary rotary electric machine of the present invention includes the above-described rotor and a stator disposed radially outside the rotor.

One aspect of an exemplary drive apparatus according to the present invention includes the above rotary electric machine, and a gear mechanism connected to the rotor.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a diagram schematically illustrating a drive apparatus according to a first embodiment;

FIG. 2 is a cross-sectional view illustrating a rotor in the first embodiment;

FIG. 3 is a cross-sectional view illustrating a part of the rotor in the first embodiment;

FIG. 4 is a cross-sectional view illustrating a part of the rotor of the first embodiment, and is a partially enlarged view of FIG. 3;

FIG. 5 is a cross-sectional view illustrating a part of a rotor in a second embodiment;

FIG. 6 is a cross-sectional view illustrating a part of a rotor in a third embodiment; and

FIG. 7 is a cross-sectional view illustrating a part of a rotor in a fourth embodiment.

### DETAILED DESCRIPTION

The following description will be made with a vertical direction being defined on the basis of the positional relationship in a case where the drive apparatus of the embodiment is mounted in a vehicle positioned on a horizontal road surface. That is, it is sufficient that the positional relationship regarding the vertical direction described in the following embodiment is satisfied in the case where the drive apparatus is mounted in a vehicle positioned on a horizontal road surface.

Each drawing illustrates an XYZ coordinate system appropriately as a three-dimensional orthogonal coordinate system. In the XYZ coordinate system, a Z-axis direction corresponds to the vertical direction. A +Z side is an upward vertical direction, and a −Z side is a downward vertical direction. In the following description, the upward vertical direction and the downward vertical direction will be referred to simply as the “upper side” and the “lower side”, respectively. An X axis direction is a direction orthogonal to the Z axis direction and is a front-rear direction of the vehicle mounted with the drive apparatus. In the following embodiment, a +X side is a front side of the vehicle, and a −X side is a rear side of the vehicle. A Y axis direction is a direction orthogonal to both the X axis direction and the Z axis direction, and is a left-right direction of the vehicle, i.e., a vehicle width direction. In the following embodiment, a +Y side is a left side of the vehicle, and a −Y side is a right side of the vehicle. In the following description, the left side in the vehicle is simply referred to as “left side”, and the right side in the vehicle is simply referred to as “right side”.

Note that the positional relationship in the front-rear direction is not limited to the positional relationship in the following embodiment, and the +X side may be the rear side of the vehicle and the −X side may be the front side of the vehicle. In this case, the +Y side corresponds to the right side of the vehicle, while the −Y side corresponds to the left side of the vehicle. In the present specification, a “parallel direction” includes a substantially parallel direction, and an “orthogonal direction” includes a substantially orthogonal direction.

The center axis J illustrated in each drawing is a virtual axis extending in the Y-axis direction, that is, the left-right direction of the vehicle. In the following description, a direction parallel to the center axis J is simply referred to an “axial direction”, a radial direction with the center axis J as a center is simply referred to a “radial direction”, and a circumferential direction with the center axis J as a center is simply referred to a “circumferential direction”.

The circumferential direction is indicated by an arrow θ in each drawing. In the following description, a side (+θ side) to which the arrow θ is directed in the circumferential direction is referred to as “one circumferential direction side”. A side (−θ side) opposite to the side to which the arrow θ is directed in the circumferential direction is referred to as “the other circumferential direction side”. The one circumferential direction side is a side that advances clockwise around the center axis J when viewed from the right side (−Y side). The other side in the circumferential direction is a side that advances counterclockwise around the center axis J when viewed from the right side.

In the following description, “radially outside” includes a case where, when a certain direction is decomposed into a component facing the radial direction and a component facing the circumferential direction, the component facing the radial direction faces radially outside. Similarly, “radially inside” includes a case where, when a certain direction is decomposed into a component facing the radial direction and a component facing the circumferential direction, the component facing the radial direction faces radially inside. In addition, “one circumferential direction side” includes a case where a component facing the circumferential direction faces one circumferential direction side when a certain direction is decomposed into a component facing the radial direction and a component facing the circumferential direction. Similarly, “the other circumferential direction side” includes a case where, when a certain direction is decomposed into a component facing the radial direction and a component facing the circumferential direction, the component facing the circumferential direction faces the other circumferential direction side.

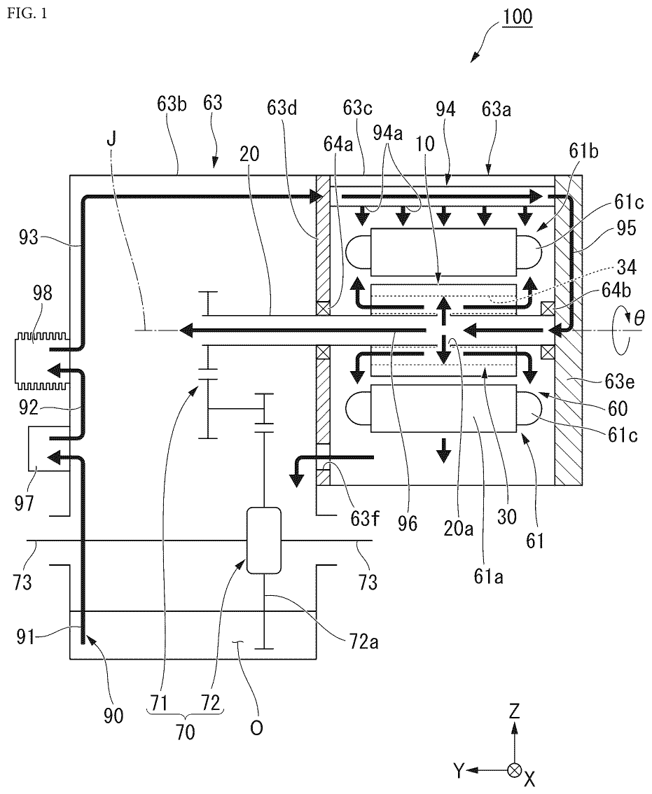

A drive apparatus 100 of the present embodiment illustrated in FIG. 1 is a drive apparatus that is mounted on a vehicle and rotates an axle 73. The vehicle mounted with the drive apparatus 100 is a vehicle with a motor as a power source, such as a hybrid vehicle (HEV), a plug-in hybrid vehicle (PHV), and an electric vehicle (EV). The drive apparatus 100 includes a rotary electric machine 60, a gear mechanism 70 connected to the rotary electric machine 60, a housing 63 accommodating the rotary electric machine 60 and the gear mechanism 70 therein, and a refrigerant flow path 90. In the present embodiment, the rotary electric machine 60 is a motor.

The housing 63 accommodates the rotary electric machine 60 and the gear mechanism 70 therein. The housing 63 includes a motor housing 63a that accommodates the rotary electric machine 60 therein and a gear housing 63b that accommodates the gear mechanism 70 therein. The motor housing 63a is connected to the right side (−Y side) of the gear housing 63b. The motor housing 63a has a peripheral wall portion 63c, a partition wall portion 63d, and a lid portion 63e. The peripheral wall portion 63c and the partition wall portion 63d are each a part of an identical single member, for example. The lid portion 63e is, for example, a separate body from the peripheral wall portion 63c and the partition wall portion 63d.

The peripheral wall portion 63c has a tubular shape that surrounds the center axis J and is open toward the right side (−Y side). The peripheral wall portion 63c surrounds the rotary electric machine 60 from radially outside. The partition wall portion 63d is connected to an end portion on the left side (+Y side) of the peripheral wall portion 63c. The partition wall portion 63d axially separates an inside of the motor housing 63a and an inside of the gear housing 63b. The partition wall portion 63d has a partition opening 63f that connects the inside of the motor housing 63a and the inside of the gear housing 63b. A bearing 64a is held by the partition wall portion 63d. The lid portion 63e is fixed to the right end portion of the peripheral wall portion 63c. The lid portion 63e closes the opening on the right side of the peripheral wall portion 63c. A bearing 64b is held by the lid portion 63e.

The gear housing 63b accommodates a refrigerant O therein. The refrigerant O is stored in a lower region in the gear housing 63b. The refrigerant O circulates through the refrigerant flow path 90. In the present embodiment, the refrigerant O is lubricating oil that cools the rotary electric machine 60 and lubricates the gear mechanism 70. As the refrigerant O, for example, oil equivalent to an automatic transmission fluid (ATF) having a relatively low viscosity is preferably used for the refrigerant function and the lubricating function.

The gear mechanism 70 is connected to a rotor 10 (to be described later) of the rotary electric machine 60, and transmits rotation about the center axis J of the rotor 10 to the axle 73 of the vehicle. The gear mechanism 70 in the present embodiment includes a reduction gear 71 connected to the rotor 10, and a differential device 72 connected to the reduction gear 71. The differential device 72 includes a ring gear 72a. To the ring gear 72a, torque output from the rotary electric machine 60 is transmitted via the reduction gear 71. The ring gear 72a has a lower end portion being immersed in the refrigerant O stored in the gear housing 63b. When the ring gear 72a rotates, the refrigerant O is scraped up, and the scraped up refrigerant O lubricates the reduction gear 71 and the differential device 72.

The rotary electric machine 60 includes the rotor 10 rotatable about the center axis J, and a stator 61 facing the rotor 10 with a gap radially interposed therebetween. In the present embodiment, the stator 61 is disposed radially outside the rotor 10. The stator 61 is fixed to an inner circumferential surface of the peripheral wall portion 63c of the housing 63. The stator 61 includes a stator core 61a and a coil assembly 61b attached to the stator core 61a.

The stator core 61a has a substantially annular shape centered on the center axis J. The stator core 61a surrounds a rotor core 30, which will be described later, of the rotor 10 from radially outside. The coil assembly 61b includes a plurality of coils 61c attached to the stator core 61a. Although not illustrated, the coil assembly 61b may include a binding member or the like to bind the respective coils 61c together, and may include a passage line for joining the coils 61c to one another.

Although not illustrated, the coil assembly 61b is electrically connected to an external power source (not illustrated). When a current is supplied from the external power source to the coil assembly 61b, each of the plurality of coils 61c constitutes an electromagnet. At this time, Joule heat is generated in each of the plurality of coils 61c, and the Joule heat is transmitted to the stator core 61a. As a result, the temperature of the stator 61 including the stator core 61a increases.

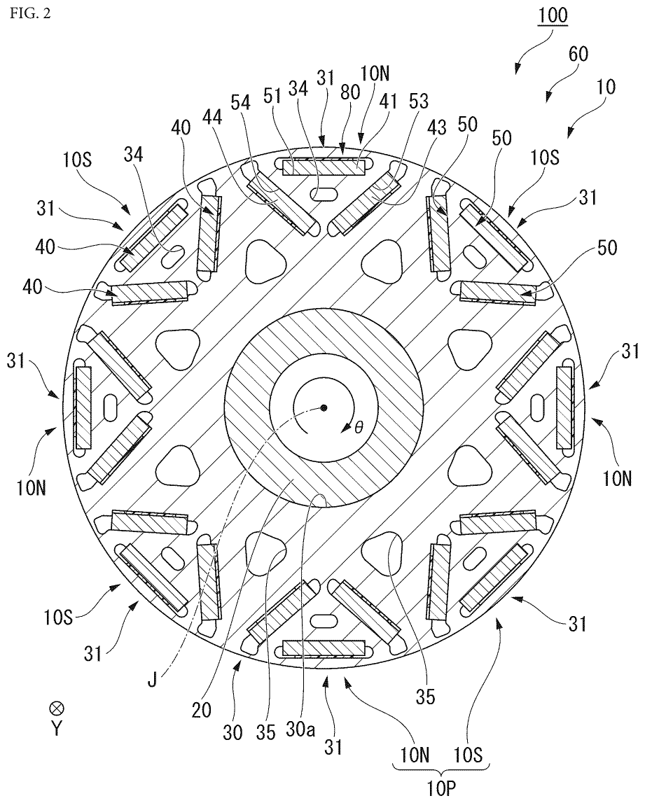

As illustrated in FIG. 2, the rotor 10 includes a shaft 20, a rotor core 30, a plurality of magnets 40, and a low thermal conductive layer 80. As illustrated in FIG. 1, the shaft 20 has a cylindrical shape extending axially about the center axis J. The shaft 20 opens to the left side (+Y side) and the right side (−Y side). The left end portion of the shaft 20 protrudes into the gear housing 63b. The shaft 20 is provided with a hole portion 20a that connects the inside of the shaft 20 and the outside of the shaft 20. A plurality of hole portions 20a are provided at intervals in the circumferential direction.

The rotor core 30 is fixed to an outer peripheral surface of the shaft 20. The rotor core 30 has a substantially annular shape centered on the center axis J. The rotor core 30 is made of a magnetic body. Although not illustrated, the rotor core 30 includes a plurality of plate members laminated in the axial direction. The plate member is, for example, an electromagnetic steel plate. As illustrated in FIG. 2, the rotor core 30 includes a through hole 30a, a plurality of magnet holding portions 31, a plurality of intra-rotor flow paths 34, and a plurality of rotor hole portions 35.

The through hole 30a axially penetrates the rotor core 30. When viewed in the axial direction, the through hole 30a has a substantially circular shape centered on the center axis J. The shaft 20 passes through the through hole 30a in the axial direction. The inner circumferential surface of the through hole 30a is fixed to the outer peripheral surface of the shaft 20.

The plurality of magnet holding portions 31 are provided in a portion on a radially outside of the rotor core 30. The plurality of magnet holding portions 31 are disposed at equal intervals over the entire circumference along the circumferential direction. In the present embodiment, eight magnet holding portions 31 are provided. In the present embodiment, each magnet holding portion 31 is provided with one intra-rotor flow path 34 and three magnet holes 50.

The plurality of magnet holes 50 extend in the axial direction. In the present embodiment, each magnet hole 50 is a hole penetrating the rotor core 30 in the axial direction. Each magnet hole 50 may be a hole having a bottom at an axial end portion. In the present embodiment, the plurality of magnet holes 50 include a first magnet hole 51 and second magnet holes 53 and 54 provided on the radially inside of the first magnet hole 51. Each of the plurality of magnet holding portions 31 is provided with one first magnet hole 51 and a pair of second magnet holes 53 and 54.

One of the plurality of magnets 40 is accommodated in each of the plurality of magnet holes 50. In the present embodiment, each of the plurality of magnets 40 has a substantially rectangular parallelepiped shape extending in the axial direction. The type of the magnet 40 is not particularly limited, and may be, for example, a neodymium magnet or a ferrite magnet. Each magnet 40 extends, for example, from the left end portion (+Y side) to the right end portion (−Y side) of the rotor core 30.

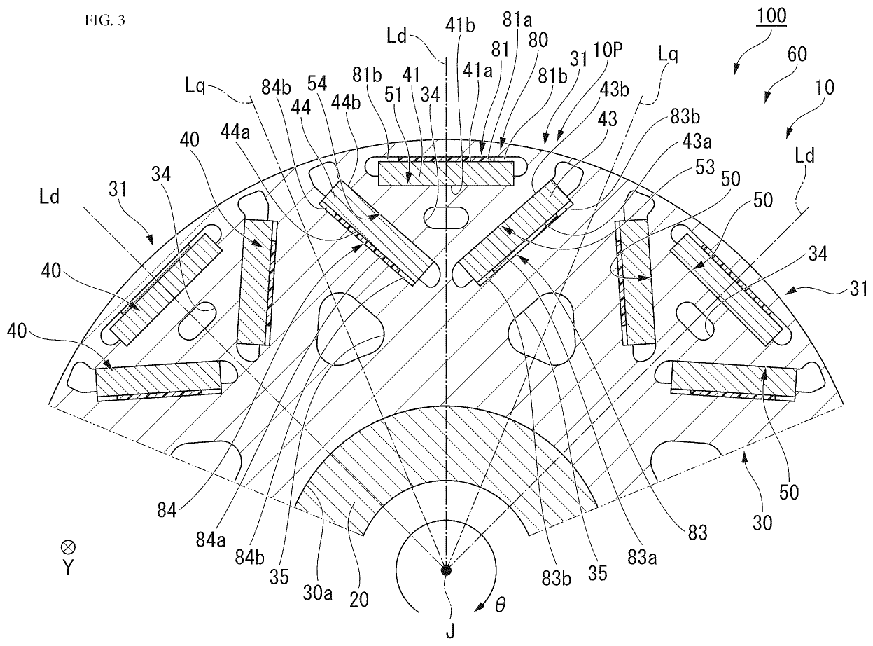

As illustrated in FIG. 3, the plurality of magnets 40 include a first magnet 41 accommodated in the first magnet hole 51 and a pair of second magnets 43 and 44 accommodated in the pair of second magnet holes 53 and 54, respectively. Each magnet 40 is fixed in each magnet hole 50 by low thermal conductive portions 81a, 83a, and 84a described later.

As illustrated in FIG. 2, the rotor 10 includes a plurality of magnetic poles 10P. A plurality of magnetic poles 10P are disposed at equal intervals over the entire circumference along the circumferential direction. In the present embodiment, eight magnetic poles 10P are provided. Each of the plurality of magnetic poles 10P includes one magnet holding portion 31 of the rotor core 30 and a plurality of magnets 40 accommodated in the magnet hole 50 provided in the one magnet holding portion 31. Each of the plurality of magnetic poles 10P includes one first magnet hole 51, a pair of second magnet holes 53 and 54, one first magnet 41, and a pair of second magnets 43 and 44. The plurality of magnetic poles 10P include four magnetic poles 10N in which the magnetic pole on the outer peripheral surface of the rotor core 30 is an N pole and four magnetic poles 10S in which the magnetic pole on the outer peripheral surface of the rotor core 30 is an S pole. Four of the magnetic poles 10N and four of the magnetic poles 10S are alternately arranged along the circumferential direction.

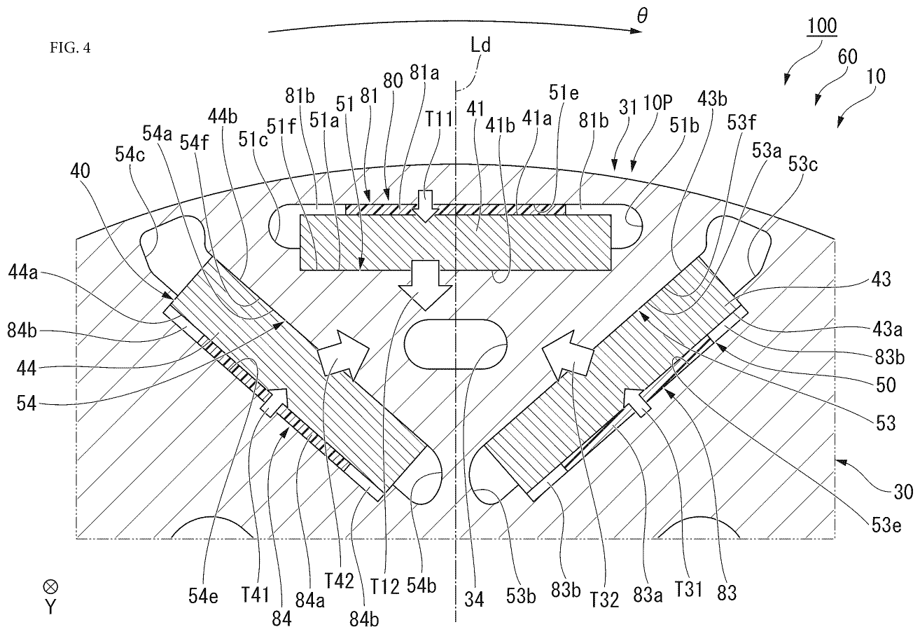

As illustrated in FIG. 4, in the magnetic pole 10P, the second magnet hole 53 and the second magnet hole 54 are disposed with a magnetic pole virtual line Ld interposed therebetween in the circumferential direction. The magnetic pole virtual line Ld is a virtual line that passes through the circumferential center of the magnetic pole 10P and extends in the radial direction. The magnetic pole virtual line Ld is provided in each of the magnetic poles 10P. The magnetic pole virtual line Ld passes through on a d axis of the rotor 10 when viewed in the axial direction. A direction where the magnetic pole virtual line Ld extends is a d-axis direction of the rotor 10. The magnetic pole virtual line Ld passes through the center in the circumferential direction between the pair of second magnet holes 53 and 54. In the present embodiment, the circumferential center of the magnetic pole 10P is the circumferential center of the magnet holding portion 31.

The first magnet hole 51 is disposed radially outside the pair of second magnet holes 53 and 54. The first magnet hole 51 is disposed between the pair of second magnet holes 53 and 54 in the circumferential direction. More specifically, the first magnet hole 51 is disposed between the radially outer end portions of the pair of second magnet holes 53 and 54. When viewed in the axial direction, the first magnet hole 51 extends in a direction orthogonal to the magnetic pole virtual line Ld. The magnetic pole virtual line Ld passes through the circumferential center of the first magnet hole 51. When viewed in the axial direction, a portion on one circumferential direction side (+θ side) with respect to the magnetic pole virtual line Ld of the first magnet hole 51 and a portion on the other circumferential direction side (−θ side) have a line-symmetrical shape with the magnetic pole virtual line Ld as a symmetry axis.

The first magnet hole 51 includes a magnet accommodation hole portion 51a and two outer hole portions 51b and 51c. When viewed in the axial direction, the magnet accommodation hole portion 51a has a rectangular shape with the direction in which the first magnet hole 51 extends as a long side. The magnet accommodation hole portion 51a is disposed on the radially outside of the intra-rotor flow path 34. The magnet accommodation hole portion 51a has a first inner surface 51e and a second inner surface 51f. The first inner surface 51e is a surface facing the radially inside among the inner surfaces of the magnet accommodation hole portion 51a. The second inner surface 51f is a surface facing radially outside among the inner surfaces of the magnet accommodation hole portion 51a.

The first magnet 41 is accommodated in the first magnet hole 51. More specifically, the first magnet 41 is accommodated in the magnet accommodation hole portion 51a. When viewed in the axial direction, the first magnet 41 extends in a direction orthogonal to the magnetic pole virtual line Ld. The first magnet 41 is disposed radially outside of the intra-rotor flow path 34. The first magnet 41 has a first outer surface 41a and a second outer surface 41b. The first outer surface 41a is a surface of the outer surface of the first magnet 41 that faces the radially outside, that is, the side opposite to the intra-rotor flow path 34 side. The first outer surface 41a faces the first inner surface 51e. The second outer surface 41b is a surface facing the radially inside, that is, the intra-rotor flow path 34 side, of the outer surface of the first magnet 41. The second outer surface 41b faces the second inner surface 51f.

The outer hole portion 51b is connected to an end portion on one circumferential direction side (+θ side) of the magnet accommodation hole portion 51a. The outer hole portion 51c is connected to an end portion on the other circumferential direction side (−θ side) of the magnet accommodation hole portion 51a. The outer hole portions 51b and 51c are, for example, hollow portions, and each constitute a flux barrier portion. The outer hole portions 51b and 51c may be filled with a nonmagnetic material such as resin, and the flux barrier portion may be constituted by the nonmagnetic material. In the present specification, the “flux barrier portion” is a portion of the rotor core 30 that can suppress passage of magnetic flux.

The pair of second magnet holes 53 and 54 is disposed radially inside the first magnet hole 51. When viewed in the axial direction, the pair of second magnet holes 53 and 54 extends in directions away from each other in the circumferential direction from radially inside toward radially outside. When viewed in the axial direction, the pair of second magnet holes 53 and 54 are disposed along a V shape expanding in the circumferential direction toward the radially outside. The second magnet hole 53 is disposed on one circumferential direction side (+θ side) of the intra-rotor flow path 34. The second magnet hole 54 is disposed on the other circumferential direction side (−θ side) of the intra-rotor flow path 34. When viewed in the axial direction, the second magnet hole 53 and the second magnet hole 54 have a line-symmetric shape with the magnetic pole virtual line Ld as a symmetry axis.

The second magnet hole 53 includes a magnet accommodation hole portion 53a, an inner hole portion 53b, and an outer hole portion 53c. When viewed in the axial direction, the magnet accommodation hole portion 53a has a rectangular shape with the direction in which the second magnet hole 53 extends as a long side. The magnet accommodation hole portion 53a has a first inner surface 53e and a second inner surface 53f. The first inner surface 53e is a surface facing the intra-rotor flow path 34 side among the inner surfaces of the magnet accommodation hole portion 53a. The second inner surface 53f is a surface facing the side opposite to the intra-rotor flow path 34 side among the inner surfaces of the magnet accommodation hole portion 53a. When viewed in the axial direction, the inner hole portion 53b is connected to the radially inner end portion of the magnet accommodation hole portion 53a. When viewed in the axial direction, the outer hole portion 53c is connected to the radially outer end portion of the magnet accommodation hole portion 53a. The inner hole portion 53b and the outer hole portion 53c constitute a flux barrier portion.

The second magnet hole 54 includes a magnet accommodation hole portion 54a, an inner hole portion 54b, and an outer hole portion 54c. When viewed in the axial direction, the magnet accommodation hole portion 54a has a rectangular shape with the direction in which the second magnet hole 54 extends as a long side. The magnet accommodation hole portion 54a has a first inner surface 54e and a second inner surface 54f. The first inner surface 54e is a surface facing the intra-rotor flow path 34 side among the inner surfaces of the magnet accommodation hole portion 54a. The second inner surface 54f is a surface facing the side opposite to the intra-rotor flow path 34 side among the inner surfaces of the magnet accommodation hole portion 54a. When viewed in the axial direction, the inner hole portion 54b is connected to the radially inner end portion of the magnet accommodation hole portion 54a. When viewed in the axial direction, the outer hole portion 54c is connected to the radially outer end portion of the magnet accommodation hole portion 54a. The inner hole portion 54b and the outer hole portion 54c constitute a flux barrier portion.

When viewed in the axial direction, the pair of second magnets 43 and 44 extend in directions away from each other in the circumferential direction toward the radially outside from the radially inside. When viewed in the axial direction, the pair of second magnets 43 and 44 are disposed along a V shape expanding in the circumferential direction toward the radial outside. The second magnet 43 is disposed in the magnet accommodation hole portion 53a. The second magnet 43 is disposed on one circumferential direction side (+θ side) of the intra-rotor flow path 34. The second magnet 44 is disposed in the magnet accommodation hole portion 54a. The second magnet 44 is disposed on the other circumferential direction side (−θ side) of the intra-rotor flow path 34. As described above, the first magnet 41 is disposed radially outside the intra-rotor flow path 34. As a result, the intra-rotor flow path 34 is surrounded by the plurality of magnets 40 in the cross section orthogonal to the center axis J.

The second magnet 43 has a first outer surface 43a and a second outer surface 43b. The first outer surface 43a is a surface of the outer surface of the second magnet 43 facing the side opposite to the intra-rotor flow path 34 side. The first outer surface 43a faces the first inner surface 53e. The second outer surface 43b is a surface of the outer surface of the second magnet 43 facing the intra-rotor flow path 34 side. The second outer surface 43b faces the second inner surface 53f.

The second magnet 44 has a first outer surface 44a and a second outer surface 44b. The first outer surface 44a is a surface of the outer surface of the second magnet 44 facing the side opposite to the intra-rotor flow path 34 side. The first outer surface 44a faces the first inner surface 54e. The second outer surface 44b is a surface of the outer surface of the second magnet 44 facing the intra-rotor flow path 34 side. The second outer surface 44b faces the second inner surface 54f.

As illustrated in FIG. 1, in the present embodiment, the plurality of intra-rotor flow paths 34 are holes penetrating the rotor core 30 in the axial direction. The plurality of intra-rotor flow paths 34 are flow paths through which the refrigerant O flows. The plurality of intra-rotor flow paths 34 extend in the axial direction. The substantially axial center portions of the plurality of intra-rotor flow paths 34 are radially connected to the plurality of hole portions 20a of the shaft 20. As illustrated in FIG. 2, in the present embodiment, eight intra-rotor flow paths 34 are provided. Each of the intra-rotor flow paths 34 is provided at equal intervals over the entire circumference along the circumferential direction. One each of the intra-rotor flow paths 34 is provided in each magnet holding portion 31. As described above, in each magnet holding portion 31, the intra-rotor flow path 34 is surrounded by one first magnet 41 and the pair of second magnets 43 and 44. The refrigerant O flows through each of the intra-rotor flow paths 34. Each of the intra-rotor flow paths 34 constitutes a part of the refrigerant flow path 90 through which the refrigerant O flows. Part of the heat of the rotor core 30 and the plurality of magnets 40 is transmitted to the refrigerant O flowing through the intra-rotor flow path 34. Part of the heat of the rotor core 30 and the plurality of magnets 40 is released via the refrigerant O.

As illustrated in FIG. 3, the intra-rotor flow path 34 is provided at a position overlapping the magnetic pole virtual line Ld when viewed in the axial direction. When viewed in the axial direction, the intra-rotor flow path 34 has an elongated hole shape extending in a direction orthogonal to the magnetic pole virtual line Ld. When viewed in the axial direction, both circumferential end portions of the intra-rotor flow path 34 have an arc shape. When viewed in the axial direction, the intra-rotor flow path 34 may have other shapes such as a circular shape and a rectangular shape. In the present embodiment, a portion of the intra-rotor flow path 34 on one circumferential direction side (+θ side) with respect to the magnetic pole virtual line Ld and a portion of the intra-rotor flow path 34 on the other side (−θ side) in the circumferential direction with respect to the magnetic pole virtual line Ld have a line-symmetrical shape with the magnetic pole virtual line Ld as a symmetry axis.

The plurality of rotor hole portions 35 are holes penetrating the rotor core 30 in the axial direction. The plurality of rotor hole portions 35 may be holes having a bottom in the axial direction. As illustrated in FIG. 2, the plurality of rotor hole portions 35 are provided at equal intervals over the entire circumference along the circumferential direction. In the present embodiment, eight rotor hole portions 35 are provided. As illustrated in FIG. 3, when viewed in the axial direction, the rotor hole portion 35 is provided at a position overlapping a second virtual line Lq that passes through the circumferential center between the magnet holding portions 31 adjacent to each other in the circumferential direction and extends in the radial direction. When viewed in the axial direction, the rotor hole portion 35 has a substantially triangular shape with rounded corners protruding radially outside. By providing the plurality of rotor hole portions 35 in the rotor core 30, the weight of the rotor core 30 can be reduced. The second virtual line Lq passes through on a q axis of the rotor 10 when viewed in the axial direction. A direction where the second virtual line Lq extends is a q-axis direction of the rotor 10.

The low thermal conductive layer 80 suppresses heat transfer from the rotor core 30 to the magnet 40. The low thermal conductive layer 80 extends in the axial direction. Although not illustrated, in the present embodiment, the low thermal conductive layer 80 is provided from an end portion on the left side (+Y side) to an end portion on the right side (−Y side) of the magnet 40. The low thermal conductive layer 80 is accommodated in each of the plurality of magnet holes 50. The low thermal conductive layer 80 includes a first low thermal conductive layer 81 and second low thermal conductive layers 83 and 84.

As illustrated in FIG. 4, the first low thermal conductive layer 81 is provided between the first outer surface 41a and the first inner surface 51e of the first magnet 41 in the first magnet hole 51. The second low thermal conductive layer 83 is provided between the first outer surface 43a and the first inner surface 53e of the second magnet 43 in the second magnet hole 53. The second low thermal conductive layer 84 is provided between the first outer surface 44a and the first inner surface 54e of the second magnet 44 in the second magnet hole 54. That is, the low thermal conductive layer 80 is provided between each of the first outer surfaces 41a, 43a, and 44a of the plurality of magnets 40 and the rotor core 30. The first low thermal conductive layer 81 includes a low thermal conductive portion 81a and a void portion 81b. The second low thermal conductive layer 83 includes a low thermal conductive portion 83a and a void portion 83b. The second low thermal conductive layer 84 includes a low thermal conductive portion 84a and a void portion 84b. The void portions 81b, 83b, and 84b are filled with air.

In the present embodiment, the low thermal conductive portions 81a, 83a, and 84a are sheet-like members. The low thermal conductive portions 81a, 83a, and 84a are inserted into the magnet holes 50 together with the magnets 40 in a state of being attached to the first outer surfaces 41a, 43a, and 44a of the magnets 40. Although not illustrated, in the present embodiment, each of the sheet-like low thermal conductive portions 81a, 83a, and 84a has a substantially rectangular shape extending in the axial direction when viewed in the thickness direction of each of the low thermal conductive portions 81a, 83a, and 84a. The low thermal conductive portions 81a, 83a, and 84a disposed in the respective magnet holes 50 are foamed by heating to expand the volume, and are cured in an expanded state. The thermal conductivity of the low thermal conductive portions 81a, 83a, and 84a is smaller than the thermal conductivity of the rotor core 30.

The low thermal conductive portion 81a presses the first magnet 41 against the second inner surface 51f of the first magnet hole 51. The low thermal conductive portion 83a presses the second magnet 43 against the second inner surface 53f of the second magnet hole 53. The low thermal conductive portion 84a presses the second magnet 44 against the second inner surface 54f of the second magnet hole 54. Thus, each magnet 40 is fixed to each magnet hole 50. As a result, the second outer surfaces 41b, 43b, and 44b of the magnets 40 come into contact with the rotor core 30.

In the present embodiment, the low thermal conductive portions 81a, 83a, and 84a include, for example, a thermosetting resin and a foaming agent foamable by heating. The foaming agent contained in the low thermal conductive portions 81a, 83a, and 84a is preferably, for example, a foaming agent that foams at a temperature lower than the curing temperature of the thermosetting resin and reaches the most expanded state. As a result, in the process in which the temperature rises during heating of the rotor 10, the thermosetting resin starts to be cured after foaming of the foaming agent is completed, so that the low thermal conductive portions 81a, 83a, and 84a stably expand. Therefore, each of the plurality of magnets 40 can be stably pressed against the second inner surfaces 51f, 53f, and 54f of the plurality of magnet holes 50 by the low thermal conductive portions 81a, 83a, and 84a, and each of the plurality of magnets 40 can be stably fixed to the magnet hole 50.

Although not illustrated, an adhesive layer is provided on each of front and back surfaces of the low thermal conductive portions 81a, 83a, and 84a of the present embodiment. As a result, each magnet 40 can be bonded and fixed to each magnet hole 50 via the low thermal conductive portions 81a, 83a, and 84a. In addition, the low thermal conductive portions 81a, 83a, and 84a can be stably brought into contact with the first outer surfaces 41a, 43a, and 44a of each of the plurality of magnets 40 and the rotor core 30. An adhesive layer may be provided only on one of the front and back surfaces of the low thermal conductive portions 81a, 83a, and 84a. That is, the low thermal conductive portions 81a, 83a, and 84a may be bonded and fixed to only one of the magnets 40 or the magnet holes 50. In addition, the low thermal conductive portions 81a, 83a, and 84a may not be provided with an adhesive layer.

When viewed in the axial direction, the void portion 81b is disposed on both sides in the direction in which the first outer surface 41a of the low thermal conductive portion 81a extends. A part of the first outer surface 41a is exposed to the void portion 81b. When viewed in the axial direction, the void portion 83b is disposed on both sides in the direction in which the first outer surface 43a of the low thermal conductive portion 83a extends. A part of the first outer surface 43a is exposed to the void portion 83b. When viewed in the axial direction, the void portion 84b is disposed on both sides in the direction in which the first outer surface 44a of the low thermal conductive portion 84a extends. A part of the first outer surface 44a is exposed to the void portion 84b. That is, parts of the first outer surfaces 41a, 43a, and 44a of the plurality of magnets 40 are exposed to the void portions 81b, 83b, and 84b, respectively. The thermal conductivity of the void portions 81b, 83b, and 84b is smaller than the thermal conductivity of the rotor core 30. The thermal conductivity of the void portions 81b, 83b, and 84b is smaller than the thermal conductivity of the low thermal conductive portions 81a, 83a, and 84a. As described above, the thermal conductivity of the low thermal conductive portions 81a, 83a, and 84a is smaller than the thermal conductivity of the rotor core 30. Therefore, the thermal conductivity of the low thermal conductive layer 80 is smaller than the thermal conductivity of the rotor core 30. As described above, the second outer surfaces 41b, 43b, and 44b of the plurality of magnets 40 are in contact with the second inner surfaces 51f, 53f, and 54f of the rotor core 30, respectively. Therefore, the thermal resistance between the rotor core 30 and the first outer surfaces 41a, 43a, and 44a facing the opposite side to the intra-rotor flow path 34 side of each of the plurality of magnets 40 is larger than the thermal resistance between the rotor core 30 and the second outer surfaces 41b, 43b, and 44b facing the intra-rotor flow path 34 side of each of the plurality of magnets 40.

In the rotor 10, a portion located on the radially outside is closer to the stator 61, so that a large amount of magnetic flux flowing between the rotor 10 and the stator 61 passes therethrough. Therefore, the magnetic flux passing through the first magnet 41 disposed radially outside the second magnets 43 and 44 is larger than the magnetic flux passing through the second magnets 43 and 44. Therefore, when the rotor 10 is rotated about the center axis J at the time of driving the drive apparatus 100, the amount of change in the magnetic flux passing through the first magnet 41 is larger than the amount of change in the magnetic flux passing through the second magnets 43 and 44, so that the eddy current generated in the first magnet 41 is larger than the eddy current generated in the second magnets 43 and 44. Therefore, since the amount of Joule heat generated by the first magnet 41 is larger than the amount of Joule heat generated by the second magnets 43 and 44, the temperature of the first magnet 41 is higher than that of the second magnets 43 and 44.

When the drive apparatus 100 is driven, the heat of the stator 61 is transferred to the outer peripheral surface of the rotor core 30 through the gap between the stator core 61a and the rotor core 30, and the radiation heat is generated by the radiation from the stator core 61a, so that the temperature of the outer peripheral surface of the rotor core 30 increases. Since the distance between the first magnet 41 disposed on the radially outside of the second magnets 43 and 44 and the outer peripheral surface of the rotor core 30 is short, the heat of the stator core 61a is easily transferred, and the temperature is easily raised as compared with the second magnets 43 and 44. As a result, when the drive apparatus 100 is driven, the first magnet 41 is likely to rise in temperature more than the second magnets 43 and 44, and is likely to demagnetize due to the rise in temperature.

The refrigerant flow path 90 is a path for supplying the refrigerant O stored in the gear housing 63b to the rotor 10 and the stator 61. As illustrated in FIG. 1, the refrigerant flow path 90 is provided with a pump 97 and a cooler 98. The refrigerant flow path 90 includes a first flow path portion 91, a second flow path portion 92, a third flow path portion 93, a fourth flow path portion 94, a fifth flow path portion 95, an intra-shaft flow path 96, and an intra-rotor flow path 34.

The first flow path portion 91, the second flow path portion 92, and the third flow path portion 93 are provided in a wall portion of the gear housing 63b, for example. The first flow path portion 91 connects a lower region in which the refrigerant O is stored in the gear housing 63b and the pump 97. The second flow path portion 92 connects the pump 97 and the cooler 98. The third flow path portion 93 connects the cooler 98 and the fourth flow path portion 94.

The fourth flow path portion 94 is a pipe extending in the axial direction. Both axial ends of the fourth flow path portion 94 are supported by the motor housing 63a. The fourth flow path portion 94 is disposed above the stator 61. The fourth flow path portion 94 has a plurality of supply ports 94a. The supply port 94a is a hole that penetrates the fourth flow path portion 94 in the radial direction. In the present embodiment, the supply port 94a is an injection port that injects a part of the refrigerant O flowing into the fourth flow path portion 94 to the outside of the fourth flow path portion 94. The fifth flow path portion 95 is provided in the lid portion 63e. The fifth flow path portion 95 connects the fourth flow path portion 94 and the intra-shaft flow path 96.

The intra-shaft flow path 96 is formed by the inner surface of the hollow shaft 20. The intra-shaft flow path 96 extends in the axial direction. An end portion on the left side (+Y side) of the intra-shaft flow path 96 is located inside the gear housing 63b and opens to the left side. As described above, the intra-rotor flow path 34 is a hole that penetrates the rotor core 30 in the axial direction. An axially central portion of the intra-rotor flow path 34 is connected to the plurality of hole portions 20a. The intra-rotor flow path 34 is connected to the intra-shaft flow path 96 via the plurality of hole portions 20a.

When the pump 97 is driven, the refrigerant O stored in the lower region in the gear housing 63b is sucked up by the pump 97 through the first flow path portion 91, and flows into the cooler 98 through the second flow path portion 92. The refrigerant O flowing into the cooler 98 is cooled in the cooler 98, and then flows into the fourth flow path portion 94 through the third flow path portion 93. A part of the refrigerant O flowing into the fourth flow path portion 94 is injected from the supply port 94a and supplied to the stator 61. The other part of the refrigerant O flowing into the fourth flow path portion 94 flows into the intra-shaft flow path 96 through the fifth flow path portion 95.

A part of the refrigerant O flowing into the intra-shaft flow path 96 flows into the intra-rotor flow path 34 via the plurality of hole portions 20a. Another part of the refrigerant O flowing through the intra-shaft flow path 96 flows into the gear housing 63b from the opening on the left side (+Y side) of the shaft 20 and is stored again in the lower region in the gear housing 63b.

The refrigerant O flowing into the intra-rotor flow path 34 flows through the intra-rotor flow path 34 toward the left side (+Y side) and the right side (−Y side). The refrigerant O flowing through the intra-rotor flow path 34 comes into contact with the inner surface of the intra-rotor flow path 34, and absorbs the heat of the rotor core 30 and the heat of the plurality of magnets 40. As a result, the heat of the rotor core 30 and the heat of the plurality of magnets 40 are released to the refrigerant O, and the rotor core 30 and the plurality of magnets 40 are cooled. The refrigerant O flowing through the intra-rotor flow path 34 scatters radially outside from both axial ends of the rotor core 30 and is supplied to the stator 61.

The refrigerant O supplied to the stator 61 from the supply port 94a of the fourth flow path portion 94 and both axial ends of the intra-rotor flow path 34 absorbs heat of the stator 61 to cool the stator 61. The refrigerant O supplied to the stator 61 falls downward and accumulates in a lower region in the motor housing 63a. The refrigerant O accumulated in the lower region in the motor housing 63a returns into the gear housing 63b via the partition opening 63f.

According to the present embodiment, the intra-rotor flow path 34 is surrounded by the plurality of magnets 40 in the cross section orthogonal to the center axis J. The thermal resistance between the rotor core 30 and the first outer surfaces 41a, 43a, and 44a facing the opposite side to the intra-rotor flow path 34 side of each of the plurality of magnets 40 is larger than the thermal resistance between the rotor core 30 and the second outer surfaces 41b, 43b, and 44b facing the intra-rotor flow path 34 side of each of the plurality of magnets 40. Therefore, the heat quantities T11, T31, and T41 flowing into the first outer surfaces 41a, 43a, and 44a of each magnet 40 from the opposite side of the intra-rotor flow path 34 side illustrated in FIG. 4 can be reduced, and the heat quantities T12, T32, and T42 released from the second outer surfaces 41b, 43b, and 44b of each magnet 40 to the intra-rotor flow path 34 side can be increased. As a result, the heat quantities T12, T32, and T42 released from the second outer surfaces 41b, 43b, and 44b of each magnet 40 to the intra-rotor flow path 34 side can be made relatively larger than the heat quantities T11, T31, and T41 flowing into the first outer surfaces 41a, 43a, and 44a of each magnet 40 from the opposite side of the intra-rotor flow path 34 side. In addition, since the intra-rotor flow path 34 is surrounded by the plurality of magnets 40, it is easy to dispose each magnet 40 close to the intra-rotor flow path 34, and it is easy to transmit the heat of each magnet 40 to the refrigerant O. As a result, the heat quantity transmitted from each magnet 40 to the refrigerant O flowing through the intra-rotor flow path 34 via the rotor core 30 can be made larger than the heat quantity transmitted from the rotor core 30 to each magnet 40. Therefore, since the heat of each magnet 40 can be stably released via the refrigerant O flowing through the intra-rotor flow path 34, the temperature rise of each magnet 40 can be suppressed.

In addition, among the plurality of magnets 40, the magnet disposed on the radially outside of the intra-rotor flow path 34 has a short distance from the outer peripheral surface of the rotor core 30, and thus, as described above, the temperature is likely to rise due to the heat supplied from the stator 61. However, in the present embodiment, since the thermal resistance between the first outer surface facing the radial outside of the magnet and the rotor core 30 can be increased, the heat quantity transmitted from the stator 61 to the first outer surface of the magnet via the rotor core 30 can be reduced. Therefore, the temperature rise of the magnet can be more suitably suppressed.

In the present embodiment, since the temperature rise of each magnet 40 can be suppressed, demagnetization of each magnet 40 can be suppressed. Therefore, it is possible to suppress a decrease in the driving efficiency of the rotary electric machine 60 and the drive apparatus 100.

According to the present embodiment, each of the plurality of magnetic poles 10P includes one first magnet 41 and the pair of second magnets 43 and 44, and the pair of second magnets 43 and 44 extends in directions away from each other in the circumferential direction from the radially inside toward the radially outside when viewed in the axial direction. Therefore, since it is easy to increase the heat quantity flowing from the second outer surfaces 41b, 43b, and 44b of the first magnet 41 and the pair of second magnets 43 and 44 toward the intra-rotor flow path 34, it is easy to increase the heat quantity transmitted from each magnet 40 to the refrigerant O flowing through the intra-rotor flow path 34 via the rotor core 30. Therefore, since the heat of each of the first magnet 41 and the second magnets 43 and 44 can be stably released via the refrigerant O flowing through the intra-rotor flow path 34, the temperature rise of each of the first magnet 41 and the second magnets 43 and 44 can be suppressed.

As described above, since the distance between the first magnet 41 disposed on the radially outside of the second magnets 43 and 44 and the outer peripheral surface of the rotor core 30 is short, the temperature is likely to rise due to the heat supplied from the stator 61. However, in the present embodiment, since the thermal resistance between the first outer surface 41a of the first magnet 41 facing the radial outside and the rotor core 30 can be increased, the heat quantity transmitted from the stator 61 to the first outer surface 41a via the rotor core 30 can be suitably suppressed, and the temperature rise of the first magnet 41 can be more suitably suppressed.

According to the present embodiment, the first magnet 41 extends in a direction orthogonal to the magnetic pole virtual line Ld that passes through the circumferential center of the magnetic pole 10P and extends in the radial direction when viewed in the axial direction. Therefore, when viewed in the axial direction, it is easy to shorten the longest distance between the second outer surface 41b and the intra-rotor flow path 34 as compared with the case where the first magnet 41 extends in the direction inclined from the direction orthogonal to the magnetic pole virtual line Ld. Therefore, since it is easy to suppress the variation in the heat radiation amount of the first magnet 41 in the circumferential direction, it is easy to suppress the temperature of a part of the first magnet 41 from becoming too high.

According to the present embodiment, the low thermal conductive layer 80 is provided between each of the first outer surfaces 41a, 43a, and 44a of the plurality of magnets 40 and the rotor core 30, and the thermal conductivity of the low thermal conductive layer 80 is smaller than the thermal conductivity of the rotor core 30. Therefore, as compared with the case where the first outer surfaces 41a, 43a, and 44a of the magnets 40 are in direct contact with the rotor core 30, the thermal resistance between the first outer surfaces 41a, 43a, and 44a of the magnets 40 and the rotor core 30 can be suitably increased, so that the heat quantity transmitted from the rotor core 30 to the magnets 40 can be reduced. Therefore, the temperature rise of each magnet 40 can be suitably suppressed.

According to the present embodiment, the low thermal conductive layer 80 has the first outer surfaces 41a, 43a, and 44a of each of the plurality of magnets 40 and the low thermal conductive portions 81a, 83a, and 84a in contact with the rotor core 30, the low thermal conductive portions 81a, 83a, and 84a are smaller in thermal conductivity than the rotor core 30, and the second outer surfaces 41b, 43b, and 44b of each of the plurality of magnets 40 are in contact with the rotor core 30. Therefore, since the second outer surfaces 41b, 43b, and 44b of the magnets 40 and the second inner surfaces 51f, 53f, and 54f of the magnet holes 50 can be stably brought into contact with each other by the low thermal conductive portions 81a, 83a, and 84a, the thermal resistance between the second outer surfaces 41b, 43b, and 44b and the rotor core 30 can be stably reduced. Therefore, since the heat quantity flowing from the second outer surfaces 41b, 43b, and 44b to the intra-rotor flow path 34 side can be stably increased, the temperature rise of each of the first magnet 41 and the second magnets 43 and 44 can be stably suppressed.

In the present embodiment, as described above, the second outer surfaces 41b, 43b, and 44b of the magnets 40 can be pressed against the second inner surfaces 51f, 53f, and 54f of the magnet holes 50 by the low thermal conductive portions 81a, 83a, and 84a. Therefore, the magnets 40 can be fixed to the magnet holes 50 by the low thermal conductive portions 81a, 83a, and 84a. Therefore, since the low thermal conductive portions 81a, 83a, and 84a can be used as a fixing material for fixing each magnet 40 to the magnet hole 50 and a heat insulating material for reducing the heat quantity transmitted from the rotor core 30 to each magnet 40, it is possible to suppress an increase in manufacturing cost of the rotor 10, the rotary electric machine 60, and the drive apparatus 100 as compared with the case where each of the fixing material and the heat insulating material is separately provided.

In the present embodiment, the low thermal conductive layer 80 has the void portions 81b, 83b, and 84b, and a part of the first outer surfaces 41a, 43a, and 44a of each of the plurality of magnets 40 is exposed to the void portions 81b, 83b, and 84b. As described above, since the thermal conductivity of the void portions 81b, 83b, and 84b is smaller than the thermal conductivity of the low thermal conductive portions 81a, 83a, and 84a, the thermal resistance between the first outer surfaces 41a, 43a, and 44a of the magnets 40 and the rotor core 30 can be increased as compared with the case where each of the low thermal conductive layers 81, 83, and 84 is formed only of the low thermal conductive portion. Therefore, since the heat quantity transmitted from the rotor core 30 to each magnet 40 can be more suitably suppressed, the temperature rise of each magnet 40 can be more suitably suppressed.

In addition, in the present embodiment, since the low thermal conductive layer 80 is constituted by the low thermal conductive portions 81a, 83a, and 84a and the void portions 81b, 83b, and 84b, it is possible to suppress an increase in volume and weight of the low thermal conductive portions 81a, 83a, and 84a as compared with the case where each of the low thermal conductive layers 81, 83, and 84 is constituted only by the low thermal conductive portion. Therefore, since it is possible to suppress an increase in manufacturing cost of the low thermal conductive layer 80, it is possible to suppress an increase in manufacturing cost of the rotor 10, the rotary electric machine 60, and the drive apparatus 100.

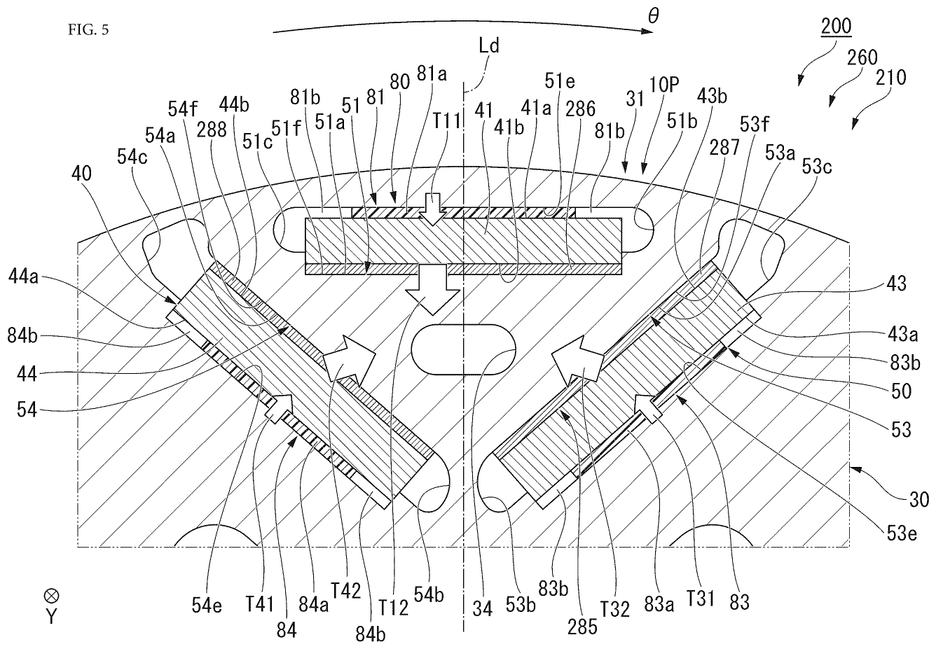

FIG. 5 is a cross-sectional view illustrating a part of a rotor 210 of a drive apparatus 200 according to a second embodiment. In the following description, the same reference numerals are given to constituent elements of the same aspects as those of the above-described embodiment, and the description thereof will be omitted.

The rotor 210 of the rotary electric machine 260 of the present embodiment includes a high thermal conductive layer 285. The high thermal conductive layer 285 enhances heat transfer from each of the plurality of magnets 40 to the rotor core 30. The high thermal conductive layer 285 extends in the axial direction. Although not illustrated, in the present embodiment, the high thermal conductive layer 285 is provided from an end portion on the left side (+Y side) to an end portion on the right side (−Y side) of the magnet 40. The high thermal conductive layer 285 is accommodated in each of the plurality of magnet holes 50. The thermal conductivity of the high thermal conductive layer 285 is higher than the thermal conductivity of the rotor core 30. The high thermal conductive layer 285 includes a first high thermal conductive layer 286 and second high thermal conductive layers 287 and 288.

The first high thermal conductive layer 286 is provided between the second outer surface 41b and the second inner surface 51f of the first magnet hole 51. The second high thermal conductive layer 287 is provided between the second outer surface 43b and the second inner surface 53f of the second magnet hole 53. The second high thermal conductive layer 288 is provided between the second outer surface 44b and the second inner surface 54f of the second magnet hole 54. That is, the high thermal conductive layer 285 is provided between each of the second outer surfaces 41b, 43b, and 44b of the plurality of magnets 40 and the rotor core 30. The second outer surfaces 41b, 43b, and 44b of the plurality of magnets 40 are in contact with the rotor core 30 via the high thermal conductive layer 285.

According to the present embodiment, the second outer surfaces 41b, 43b, and 44b of the plurality of magnets 40 are in contact with the rotor core 30 via the high thermal conductive layer 285, and the thermal conductivity of the high thermal conductive layer 285 is larger than the thermal conductivity of the rotor core 30. Therefore, as compared with the case where the second outer surfaces 41b, 43b, and 44b of the magnets 40 are in direct contact with the rotor core 30, the thermal resistance between the second outer surfaces 41b, 43b, and 44b of the magnets 40 and the rotor core 30 can be reduced. Therefore, the heat quantity flowing from the second outer surfaces 41b, 43b, and 44b of the magnets toward the intra-rotor flow path 34 can be more suitably increased, and the heat quantity transferred from each magnet 40 to the refrigerant O flowing through the intra-rotor flow path 34 via the rotor core 30 can be more suitably increased. Therefore, since the heat of each magnet 40 can be more stably released, the temperature rise of each magnet 40 can be more suitably suppressed.

In the present embodiment, the thickness of the first high thermal conductive layer 286 is substantially the same as the thickness of the low thermal conductive portion 81a. In the direction in which the first magnet 41 extends, the dimension of the first high thermal conductive layer 286 is larger than the dimension of the low thermal conductive portion 81a. The thickness of the second high thermal conductive layer 287 is substantially the same as the thickness of the low thermal conductive portion 83a. In the direction in which the second magnet 43 extends, the dimension of the second high thermal conductive layer 287 is larger than the dimension of the low thermal conductive portion 83a. The thickness of the second high thermal conductive layer 288 is substantially the same as the thickness of the low thermal conductive portion 84a. In the direction in which the second magnet 44 extends, the dimension of the second high thermal conductive layer 288 is larger than the dimension of the low thermal conductive portion 84a. Therefore, when viewed in the axial direction, the area of the low thermal conductive portion is smaller than the area of the high thermal conductive layer 285. In the present specification, the area of the low thermal conductive portion is an area obtained by adding the areas of the three low thermal conductive portions 81a, 83a, and 84a viewed in the axial direction.

According to the present embodiment, the area of the low thermal conductive portion is smaller than the area of the high thermal conductive layer 285 when viewed in the axial direction. Therefore, when viewed in the axial direction, it is easy to relatively increase the areas of the void portions 81b, 83b, and 84b with respect to the areas of the low thermal conductive portions 81a, 83a, and 84a, so that it is easy to increase the thermal resistance between the first outer surfaces 41a, 43a, and 44a of the magnets 40 and the rotor core 30. Therefore, the heat quantity transmitted from the rotor core 30 to each magnet 40 can be suitably suppressed. In addition, since it is easy to increase the area of the high thermal conductive layer 285 when viewed in the axial direction, it is easy to reduce the thermal resistance between the second outer surfaces 41b, 43b, and 44b of the magnets 40 and the rotor core 30. Therefore, the heat quantity transmitted from each magnet 40 to the refrigerant O flowing through the intra-rotor flow path 34 via the rotor core 30 can be suitably increased. Thus, the temperature rise of each magnet 40 can be more suitably suppressed.

In the present embodiment, the high thermal conductive layer 285 is made of, for example, a thermosetting resin containing a powdery thermally conductive filler. As the thermally conductive filler, for example, a metal material having a higher thermal conductivity than that of an electromagnetic steel plate such as silver or copper can be used. The thermosetting resin is preferably composed of a thermosetting adhesive such as an epoxy-based adhesive and a phenol-based adhesive. In the present embodiment, the high thermal conductive layer 285 is applied to at least one of the second outer surfaces 41b, 43b, and 44b of the magnets 40 and the second inner surfaces 51f, 53f, and 54f of the magnet holes 50, and in a state where the low thermal conductive portions 81a, 83a, and 84a are attached to the first outer surfaces 41a, 43a, and 44a of the magnets 40, each magnet 40 is inserted into each magnet hole 50 and the rotor 10 is heated, so that the low thermal conductive portions 81a, 83a, and 84a are foamed and cured, and the high thermal conductive layer 285 is cured. As a result, due to the expansion of each of the low thermal conductive portions 81a, 83a, and 84a, the high thermal conductive layer 285 can be cured while each of the magnets 40 is pressed against the second inner surfaces 51f, 53f, and 54f of each of the magnet holes 50 via the high thermal conductive layer 285. Therefore, the second outer surfaces 41b, 43b, and 44b of the plurality of magnets 40 can be stably brought into contact with the rotor core 30 via the high thermal conductive layer 285.

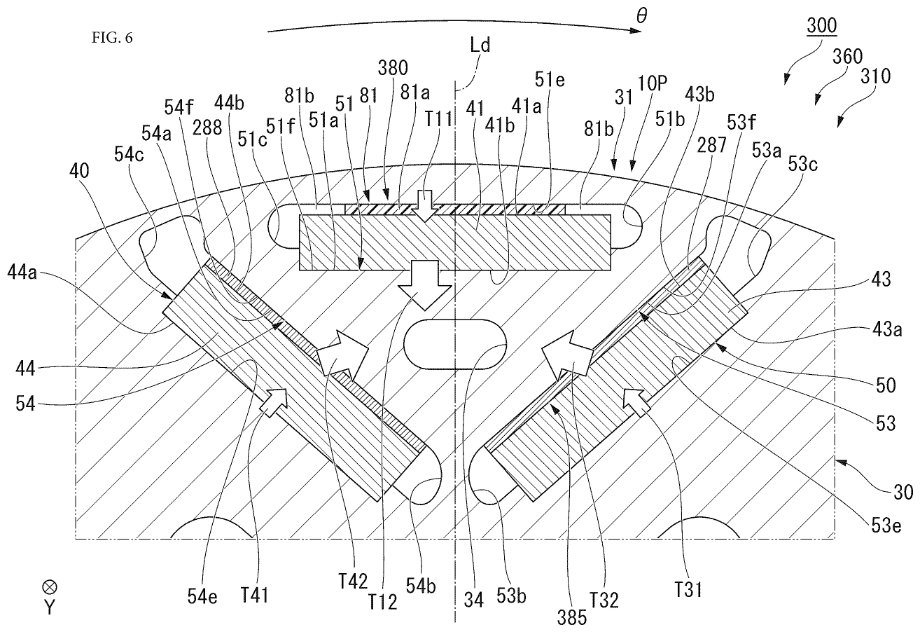

FIG. 6 is a cross-sectional view illustrating a part of a rotor 310 of a drive apparatus 300 according to a third embodiment. In the following description, the same reference numerals are given to constituent elements of the same aspects as those of the above-described embodiment, and the description thereof will be omitted.

The rotor 310 of the present embodiment includes a low thermal conductive layer 380 and a high thermal conductive layer 385. The low thermal conductive layer 380 of the present embodiment includes only the first low thermal conductive layer 81. That is, the low thermal conductive layer 380 does not include the second low thermal conductive layers 83 and 84 included in the low thermal conductive layer 80 of the above-described embodiment. Note that the configuration and the like of the first low thermal conductive layer 81 of the present embodiment are the same as the configuration and the like of the first low thermal conductive layer 81 of the above-described embodiment. The thermal conductivity of the low thermal conductive layer 380 is smaller than the thermal conductivity of the rotor core 30.

In the present embodiment, the first outer surface 41a of the first magnet 41 is in contact with the first inner surface 51e of the first magnet hole 51 via the first low thermal conductive layer 81. That is, the first outer surface 41a of the first magnet 41 is in contact with the rotor core 30 via the low thermal conductive layer 380. The second outer surface 41b of the first magnet 41 is in direct contact with the second inner surface 51f. That is, the second outer surface 41b is in direct contact with the rotor core 30.

The high thermal conductive layer 385 of the present embodiment includes only the second high thermal conductive layers 287 and 288. That is, the high thermal conductive layer 385 does not include the first high thermal conductive layer 286 included in the high thermal conductive layer 285 of the second embodiment described above. The configuration and the like of the second high thermal conductive layers 287 and 288 of the present embodiment are the same as the configuration and the like of the second high thermal conductive layers 287 and 288 of the second embodiment described above. The thermal conductivity of the high thermal conductive layer 385 is higher than the thermal conductivity of the rotor core 30.

In the present embodiment, the second outer surface 43b of the second magnet 43 is in contact with the second inner surface 53f of the second magnet hole 53 via the second high thermal conductive layer 287. The second outer surface 44b of the second magnet 44 is in contact with the second inner surface 54f of the second magnet hole 54 via the second high thermal conductive layer 288. That is, the second outer surfaces 43b and 44b of the second magnets 43 and 44 are in contact with the rotor core 30 via the high thermal conductive layer 385. In the present embodiment, the first outer surfaces 43a and 44a of the second magnets 43 and 44 are in direct contact with the first inner surfaces 53e and 54e.

According to the present embodiment, the second outer surfaces 43b and 44b of the second magnets 43 and 44 are in contact with the rotor core 30 via the high thermal conductive layer 385, the first outer surface 41a of the first magnet 41 is in contact with the rotor core 30 via the low thermal conductive layer 380, and the second outer surface 41b of the first magnet 41 is in direct contact with the rotor core 30. The thermal conductivity of the low thermal conductive layer 380 is smaller than the thermal conductivity of the rotor core 30, and the thermal conductivity of the high thermal conductive layer 385 is larger than the thermal conductivity of the rotor core 30. Therefore, in the first magnet 41 disposed on the radially outside of the second magnets 43 and 44, since the thermal resistance between the first outer surface 41a facing the radially outside and the rotor core 30 can be increased, the heat quantity transmitted from the stator 61 to the first outer surface 41a of the first magnet 41 via the rotor core 30 can be reduced. Therefore, the temperature rise of the first magnet 41 can be suppressed. In the second magnets 43 and 44, since the thermal resistance between the second outer surfaces 43b and 44b facing the intra-rotor flow path 34 and the rotor core 30 can be reduced, the heat quantity transmitted from the second magnets 43 and 44 to the refrigerant O flowing through the intra-rotor flow path 34 via the rotor core 30 can be increased. Therefore, since the heat of each of the second magnets 43 and 44 can be stably released, the temperature rise of each of the second magnets 43, 44 can be suitably suppressed.

In the present embodiment, a high thermal conductive layer is not provided between the first magnet 41 and the rotor core 30, and a low thermal conductive layer is not provided between the second magnets 43 and 44 and the rotor core 30. Therefore, since it is possible to suppress an increase in the usage amount of the low thermal conductive portion constituting the low thermal conductive layer and the high thermal conductive layer, it is possible to suppress an increase in the manufacturing cost of the rotor 310, the rotary electric machine 360, and the drive apparatus 300.

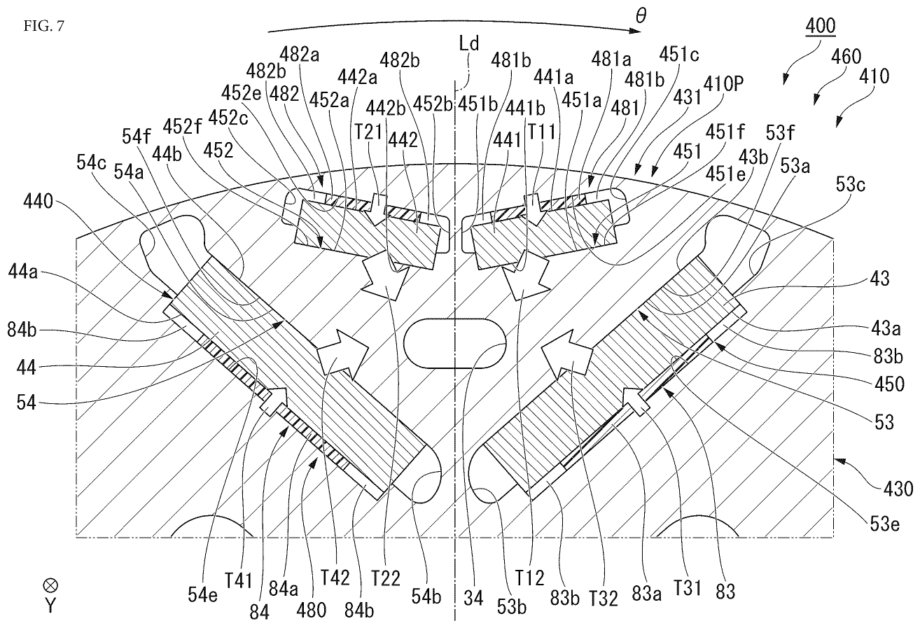

FIG. 7 is a cross-sectional view illustrating a part of a rotor 410 of a drive apparatus 400 according to a fourth embodiment. In the following description, the same reference numerals are given to constituent elements of the same aspects as those of the above-described embodiment, and the description thereof will be omitted.

The rotor 410 of the rotary electric machine 460 of the present embodiment includes a shaft 20, a rotor core 430, a plurality of magnets 440, and a low thermal conductive layer 480. The rotor core 430 includes a plurality of magnet holding portions 431 and a plurality of intra-rotor flow paths 34. The configurations and the like of the plurality of intra-rotor flow paths 34 of the present embodiment are the same as the configurations and the like of the plurality of intra-rotor flow paths 34 of the first embodiment described above.

In the present embodiment, one intra-rotor flow path 34 and a plurality of magnet holes 450 are provided in the plurality of magnet holding portions 431. In the present embodiment, the plurality of magnet holes 450 include first magnet holes 451 and 452 and a pair of second magnet holes 53 and 54 provided radially inside the first magnet holes 451 and 452. Each of the plurality of magnet holding portions 431 is provided with a pair of first magnet holes 451 and 452 and a pair of second magnet holes 53 and 54. The configurations and the like of the second magnet holes 53 and 54 of the present embodiment are the same as the configurations and the like of the second magnet holes 53 and 54 of the above-described embodiment.

In the present embodiment, the plurality of magnets 440 include a pair of first magnets 441 and 442 accommodated in each of the pair of first magnet holes 451 and 452 and a pair of second magnets 43 and 44 accommodated in each of the pair of second magnet holes 53 and 54. The configurations and the like of the second magnets 43 and 44 of the present embodiment are the same as the configurations and the like of the second magnets 43 and 44 of the above-described embodiment.

In the present embodiment, each of the plurality of magnetic poles 410P includes one magnet holding portion 431 and a plurality of magnets 440 accommodated in the magnet holes 450 provided in the one magnet holding portion 431. Each of the plurality of magnetic poles 410P includes a pair of first magnet holes 451 and 452, a pair of second magnet holes 53 and 54, a pair of first magnets 441 and 442, and a pair of second magnets 43 and 44. The other configurations of the plurality of magnetic poles 410P are the same as the other configurations of the plurality of magnetic poles 10P of the above-described embodiment.

In each of the magnetic pole 410P, the first magnet hole 451 and the first magnet hole 452 are arranged with the magnetic pole virtual line Ld interposed therebetween in the circumferential direction. The magnetic pole virtual line Ld passes through the circumferential center between the pair of first magnet holes 451 and 452. The pair of first magnet holes 451 and 452 is disposed between the pair of second magnet holes 53 and 54 in the circumferential direction. When viewed in the axial direction, the pair of first magnet holes 451 and 452 extends in directions away from each other in the circumferential direction from radially inside toward radially outside. When viewed in the axial direction, the pair of first magnet holes 451 and 452 are disposed along a V shape expanding in the circumferential direction toward the radially outside. When viewed in the axial direction, the first magnet hole 451 and the first magnet hole 452 have a line-symmetric shape with the magnetic pole virtual line Ld as a symmetry axis.

The first magnet hole 451 includes a magnet accommodation hole portion 451a, an inner hole portion 451b, and an outer hole portion 451c. When viewed in the axial direction, the magnet accommodation hole portion 451a has a rectangular shape with the direction in which the first magnet hole 451 extends as a long side. The magnet accommodation hole portion 451a is disposed radially outside the intra-rotor flow path 34 and on one circumferential direction side (+θ side). The magnet accommodation hole portion 451a has a first inner surface 451e and a second inner surface 451f. The first inner surface 451e is a surface facing the intra-rotor flow path 34 side among the inner surfaces of the magnet accommodation hole portion 451a. The second inner surface 451f is a surface facing the side opposite to the intra-rotor flow path 34 side among the inner surfaces of the magnet accommodation hole portion 451a. The inner hole portion 451b is connected to the radially inner end portion of the magnet accommodation hole portion 451a. The outer hole portion 451c is connected to the radially outer end portion of the magnet accommodation hole portion 451a. The inner hole portion 451b and the outer hole portion 451c constitute a flux barrier portion.

The first magnet hole 452 includes a magnet accommodation hole portion 452a, an inner hole portion 452b, and an outer hole portion 452c. When viewed in the axial direction, the magnet accommodation hole portion 452a has a rectangular shape with the direction in which the first magnet hole 452 extends as a long side. The magnet accommodation hole portion 451a is disposed radially outside the intra-rotor flow path 34 and on the other circumferential direction side (−θ side). The magnet accommodation hole portion 452a has a first inner surface 452e and a second inner surface 452f. The first inner surface 452e is a surface facing the intra-rotor flow path 34 side among the inner surfaces of the magnet accommodation hole portion 452a. The second inner surface 452f is a surface facing the side opposite to the intra-rotor flow path 34 side among the inner surfaces of the magnet accommodation hole portion 452a. The inner hole portion 452b is connected to the radially inner end portion of the magnet accommodation hole portion 452a. The outer hole portion 452c is connected to the radially outer end portion of the magnet accommodation hole portion 452a. The inner hole portion 452b and the outer hole portion 452c constitute a flux barrier portion. The other configuration and the like of each of the first magnet holes 451 and 452 are the same as the other configuration and the like of the first magnet hole 51 of the above-described embodiment.

When viewed in the axial direction, the pair of first magnets 441 and 442 extend in directions away from each other in the circumferential direction toward the radially outside from the radially inside. When viewed in the axial direction, the pair of first magnets 441 and 442 are disposed along a V shape expanding in the circumferential direction toward the radial outside. The first magnet 441 is disposed in the magnet accommodation hole portion 451a. The first magnet 441 is disposed radially outside the intra-rotor flow path 34 and on one circumferential direction side (+θ side). The first magnet 442 is disposed in the magnet accommodation hole portion 452a. The first magnet 442 is disposed radially outside the intra-rotor flow path 34 and on the other circumferential direction side (−θ side). In a cross section orthogonal to the center axis J, the intra-rotor flow path 34 is surrounded by the plurality of magnets 440.

The first magnet 441 has a first outer surface 441a and a second outer surface 441b. The first outer surface 441a is a surface of the outer surface of the first magnet 441 facing the side opposite to the intra-rotor flow path 34 side. The first outer surface 441a faces the first inner surface 451e. The second outer surface 441b is a surface of the outer surface of the first magnet 441 facing the intra-rotor flow path 34 side. The second outer surface 441b faces the second inner surface 451f.

The first magnet 442 has a first outer surface 442a and a second outer surface 442b. The first outer surface 442a is a surface of the outer surface of the first magnet 442 facing the side opposite to the intra-rotor flow path 34 side. The first outer surface 442a faces the first inner surface 452e. The second outer surface 442b is a surface of the outer surface of the first magnet 442 facing the intra-rotor flow path 34 side. The second outer surface 442b faces the second inner surface 452f. The other configuration and the like of each of the first magnets 441 and 442 are the same as the other configuration and the like of the first magnet 41 of the above-described embodiment.

The low thermal conductive layer 480 is accommodated in each of the plurality of magnet holes 450. The low thermal conductive layer 480 includes first low thermal conductive layers 481 and 482 and second low thermal conductive layers 83 and 84. The configurations and the like of the second low thermal conductive layers 83 and 84 of the present embodiment are the same as the configurations and the like of the second low thermal conductive layers 83 and 84 of the above-described embodiment.

The first low thermal conductive layer 481 is provided between the first outer surface 441a and the first inner surface 451e in the first magnet hole 451. The first low thermal conductive layer 482 is provided between the first outer surface 442a and the first inner surface 452e in the first magnet hole 452. That is, the first low thermal conductive layer 481 is provided between each of the first outer surfaces 441a and 442a of the first magnets 441 and 442 and the rotor core 430. The thermal conductivity of the first low thermal conductive layers 481 and 482 is smaller than the thermal conductivity of the rotor core 430. The first low thermal conductive layer 481 includes a low thermal conductive portion 481a and a void portion 481b. The first low thermal conductive layer 482 includes a low thermal conductive portion 482a and a void portion 482b.

The low thermal conductive portion 481a presses the first magnet 441 against the second inner surface 451f. The low thermal conductive portion 482a presses the first magnet 442 against the second inner surface 452f. Thus, each of the first magnets 441 and 442 is fixed to the first magnet holes 451 and 452. Thus, each of the second outer surfaces 441b and 442b of the first magnets 441 and 442 is in contact with the rotor core 430. The thermal conductivity of the low thermal conductive portions 481a and 482a is smaller than the thermal conductivity of the rotor core 430. Other configurations and the like of the low thermal conductive portions 481a and 482a are the same as other configurations and the like of the low thermal conductive portion 81a of the above-described embodiment.

When viewed in the axial direction, the void portion 481b is disposed on both sides in the direction in which the first outer surface 441a of the low thermal conductive portion 481a extends. A part of the first outer surface 441a of the first magnet 441 is exposed to the void portion 481b. When viewed in the axial direction, the void portion 482b is disposed on both sides in the direction in which the first outer surface 442a of the low thermal conductive portion 482a extends. A part of the first outer surface 442a of the first magnet 442 is exposed to the void portion 482b. The other configurations and the like of the void portions 481b and 482b are the same as the other configurations and the like of the void portion 81b of the above-described embodiment.

As described above, the second outer surfaces 441b and 442b of the first magnets 441 and 442 are in contact with the second inner surfaces 451f and 452f of the rotor core 430, respectively. The first outer surfaces 441a and 442a of the first magnets 441 and 442 are in contact with the first inner surfaces 451e and 452e of the rotor core 430 via the first low thermal conductive layers 481 and 482 having thermal conductivity lower than that of the rotor core 430. Therefore, the thermal resistance between the rotor core 430 and the first outer surfaces 441a and 442a facing the opposite side to the intra-rotor flow path 34 side of each of the first magnets 441 and 442 is larger than the thermal resistance between the rotor core 430 and the second outer surfaces 441b and 442b facing the intra-rotor flow path 34 side of each of the first magnets 441 and 442.

According to the present embodiment, each of the plurality of magnetic poles 410P includes the pair of first magnets 441 and 442, and the pair of first magnets 441 and 442 extends in directions away from each other in the circumferential direction from the radially inside toward the radially outside when viewed in the axial direction. In addition, the thermal resistance between the rotor core 430 and the first outer surfaces 441a and 442a facing the opposite side to the intra-rotor flow path 34 side of each of the pair of first magnets 441 and 442 is larger than the thermal resistance between the rotor core 430 and the second outer surfaces 441b and 442b facing the intra-rotor flow path 34 side of each of the pair of first magnets 441 and 442. Therefore, the heat quantities T12 and T22 released from the second outer surfaces 441b and 442b of each of the pair of first magnets 441 and 442 toward the intra-rotor flow path 34 can be made larger than the heat quantities T11 and T21 flowing from the rotor core 430 to the first outer surfaces 441a and 442a of each of the pair of first magnets 441 and 442. In addition, since the intra-rotor flow path 34 is surrounded by the plurality of magnets 440, it is easy to dispose the pair of first magnets 441 and 442 close to the intra-rotor flow path 34, and it is easy to suitably transmit the heat of the pair of first magnets 441 and 442 to the refrigerant O. Therefore, the heat quantity transferred from each of the pair of first magnets 441 and 442 to the refrigerant O flowing through the intra-rotor flow path 34 via the rotor core 30 can be made larger than the heat quantity transferred from the rotor core 30 to each of the pair of first magnets 441 and 442. Therefore, since the heat of each of the pair of first magnets 441 and 442 can be stably released via the refrigerant O flowing through the intra-rotor flow path 34, the temperature rise of each of the pair of first magnets 441 and 442 can be suppressed.

In the present embodiment, the above-described high thermal conductive layer may be provided between each of the second outer surfaces 441b, 442b, 43b, and 44b of the plurality of magnets 440 and the rotor core 430, and in this case, the temperature rise of each of the plurality of magnets 440 can be more suitably suppressed. In addition, a high thermal conductive layer may be provided between one or more second outer surfaces of the second outer surfaces 441b, 442b, 43b, and 44b of each of the plurality of magnets 440 and the rotor core 430.

The present invention is not limited to the above-described embodiments, and other configurations and other methods can be employed within the scope of the technical idea of the present invention. The intra-rotor flow path may have any shape or may be disposed in any manner as long as it is surrounded by a plurality of magnets when viewed in the axial direction. For example, when viewed in the axial direction, the intra-rotor flow path may have a circular shape, a rectangular shape, or the like. The type of the refrigerant flowing in the intra-rotor flow path is not particularly limited. A method of supplying the refrigerant into the intra-rotor flow path may be any method.

The configuration of the low thermal conductive layer is not limited to the present embodiment, and for example, the low thermal conductive layer may not have the void portion, and the low thermal conductive layer may be constituted only by the low thermal conductive portion, or the low thermal conductive portion may be disposed on both sides in the direction in which the first outer surface of the void portion extends. In addition, the configurations of the plurality of low thermal conductive layers may be different from each other. For example, one low thermal conductive layer may have a void portion, and the other low thermal conductive layers may not have a void portion.

The number of intra-rotor flow paths provided in one magnet holding portion is not particularly limited as long as it is one or more. When a plurality of intra-rotor flow paths are provided in one magnet holding portion, the plurality of intra-rotor flow paths may be disposed side by side at intervals in the radial direction, or may be disposed side by side at intervals in the circumferential direction. In addition, the rotor hole portion may not be provided.

A rotary electric machine to which the present invention is applied is not limited to a motor, and may be a generator. The application of the rotary electric machine is not particularly limited. The rotary electric machine may be mounted in a device other than the vehicle. The application of the drive apparatus to which the present invention is applied is not particularly limited. For example, the drive apparatus may be mounted in a vehicle for a purpose other than the purpose of rotating the axle, or may be mounted on a device other than the vehicle. The posture when the rotary electric machine and the drive apparatus are used is not particularly limited. The center axis of the rotary electric machine may be inclined with respect to the horizontal direction orthogonal to the vertical direction or may extend in the vertical direction.

Although the embodiment of the present invention has been described above, the respective configurations in the embodiment and combinations thereof are merely examples, and addition, omission, substitution, and other alterations may be appropriately made within a range not departing from the gist of the present invention. Also note that the present invention is not limited by the embodiment.

Note that the present technique can have a configuration below.
(1) A rotor rotatable about a center axis, the rotor including: a rotor core having a plurality of magnet holes and a flow path through which a refrigerant flows; and a plurality of magnets accommodated in each of the plurality of magnet holes, in which the plurality of magnet holes and the flow path each extend in an axial direction, the flow path is surrounded by the plurality of magnets in a cross section orthogonal to the center axis, and a thermal resistance between a first outer surface facing a side opposite to a side of the flow path of each of the plurality of magnets and the rotor core is larger than a thermal resistance between a second outer surface facing the side of the flow path of each of the plurality of magnets and the rotor core.
(2) The rotor according to (1), including: a plurality of magnetic poles arranged along a circumferential direction, in which the plurality of magnets include a first magnet and a second magnet, the plurality of magnet holes include a first magnet hole that accommodates the first magnet and a second magnet hole that is disposed on a radial inside of the first magnet hole and accommodates the second magnet, each of the plurality of magnetic poles includes at least one of the first magnets and a pair of the second magnets, and the pair of second magnets extends in directions away from each other in a circumferential direction from a radial inside toward a radial outside when viewed in an axial direction.
(3) The rotor according to (2), in which each of the plurality of magnetic poles includes one first magnet, and the first magnet extends in a direction orthogonal to a magnetic pole virtual line that passes through a circumferential center of the magnetic pole and extends in a radial direction when viewed in an axial direction.
(4) The rotor according to (2), in which each of the plurality of magnetic poles includes a pair of the first magnets, and the pair of first magnets extends in directions away from each other in a circumferential direction from a radial inside toward a radial outside when viewed in an axial direction.
(5) The rotor according to any one of (1) to (4), in which a low thermal conductive layer is provided between the first outer surface of each of the plurality of magnets and the rotor core, and a thermal conductivity of the low thermal conductive layer is smaller than a thermal conductivity of the rotor core.
(6) The rotor according to (5), in which the low thermal conductive layer includes a low thermal conductive portion in contact with the first outer surface of each of the plurality of magnets and the rotor core, a thermal conductivity of the low thermal conductive portion is smaller than a thermal conductivity of the rotor core, and the second outer surface of each of the plurality of magnets is in contact with the rotor core.
(7) The rotor according to (6), in which the low thermal conductive layer has a void portion, and a part of the first outer surface of each of the plurality of magnets is exposed to the void portion.
(8) The rotor according to (6) or (7), in which the second outer surface of each of the plurality of magnets is in contact with the rotor core via a high thermal conductive layer, and a thermal conductivity of the high thermal conductive layer is larger than a thermal conductivity of the rotor core.
(9) The rotor according to (8), in which an area of the low thermal conductive portion is smaller than an area of the high thermal conductive layer when viewed in an axial direction.
(10) The rotor according to any one of (2) to (4), in which the second outer surface of the second magnet is in contact with the rotor core via a high thermal conductive layer, the first outer surface of the first magnet is in contact with the rotor core via a low thermal conductive layer, the second outer surface of the first magnet is in direct contact with the rotor core, and a thermal conductivity of the low thermal conductive layer is lower than a thermal conductivity of the rotor core, and a thermal conductivity of the high thermal conductive layer is higher than a thermal conductivity of the rotor core.
(11) A rotary electric machine including: a rotor according to any one of (1) to (10); and a stator disposed on a radial outside of the rotor.
(12) A drive apparatus including: a rotary electric machine according to (11); and a gear mechanism that is connected to the rotor.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor rotatable about a center axis, the rotor comprising:
a rotor core having a plurality of magnet holes and a flow path through which a refrigerant flows; and
a plurality of magnets accommodated in each of the plurality of magnet holes, wherein
the plurality of magnet holes and the flow path each extend in an axial direction,
the flow path is surrounded by the plurality of magnets in a cross section orthogonal to the center axis, and
a thermal resistance between a first outer surface facing a side opposite to a side of the flow path of each of the plurality of magnets and the rotor core is larger than a thermal resistance between a second outer surface facing the side of the flow path of each of the plurality of magnets and the rotor core.

2. The rotor according to claim 1, comprising a plurality of magnetic poles arranged along a circumferential direction, wherein
the plurality of magnets include a first magnet and a second magnet,
the plurality of magnet holes include a first magnet hole that accommodates the first magnet and a second magnet hole that is disposed on a radial inside of the first magnet hole and accommodates the second magnet,
each of the plurality of magnetic poles includes at least one of the first magnets and a pair of the second magnets, and
the pair of second magnets extends in directions away from each other in a circumferential direction from a radial inside toward a radial outside when viewed in an axial direction.

3. The rotor according to claim 2, wherein
each of the plurality of magnetic poles includes one first magnet, and
the first magnet extends in a direction orthogonal to a magnetic pole virtual line that passes through a circumferential center of the magnetic pole and extends in a radial direction when viewed in an axial direction.

4. The rotor according to claim 2, wherein
each of the plurality of magnetic poles includes a pair of the first magnets, and
the pair of first magnets extends in directions away from each other in a circumferential direction from a radial inside toward a radial outside when viewed in an axial direction.

5. The rotor according to claim 1, wherein
a low thermal conductive layer is provided between the first outer surface of each of the plurality of magnets and the rotor core, and
a thermal conductivity of the low thermal conductive layer is smaller than a thermal conductivity of the rotor core.

6. The rotor according to claim 5, wherein
the low thermal conductive layer includes a low thermal conductive portion in contact with the first outer surface of each of the plurality of magnets and the rotor core,
a thermal conductivity of the low thermal conductive portion is smaller than a thermal conductivity of the rotor core, and
the second outer surface of each of the plurality of magnets is in contact with the rotor core.

7. The rotor according to claim 6, wherein
the low thermal conductive layer has a void portion, and
a part of the first outer surface of each of the plurality of magnets is exposed to the void portion.

8. The rotor according to claim 6, wherein
the second outer surface of each of the plurality of magnets is in contact with the rotor core via a high thermal conductive layer, and
a thermal conductivity of the high thermal conductive layer is larger than a thermal conductivity of the rotor core.

9. The rotor according to claim 8, wherein an area of the low thermal conductive portion is smaller than an area of the high thermal conductive layer when viewed in an axial direction.

10. The rotor according to claim 2, wherein
the second outer surface of the second magnet is in contact with the rotor core via a high thermal conductive layer,
the first outer surface of the first magnet is in contact with the rotor core via a low thermal conductive layer,
the second outer surface of the first magnet is in direct contact with the rotor core, and
a thermal conductivity of the low thermal conductive layer is lower than a thermal conductivity of the rotor core, and a thermal conductivity of the high thermal conductive layer is higher than a thermal conductivity of the rotor core.

11. A rotary electric machine comprising:
the rotor according to claim 1; and
a stator disposed on a radial outside of the rotor.

12. A drive apparatus comprising:
the rotary electric machine according to claim 11; and
a gear mechanism that is connected to the rotor.
